(19) United States
(12) Patent Application Publication
(10) Pub. No.: US 2026/0177398 A1
(43) Pub. Date: Jun. 25, 2026

(54) METHOD, APPARATUS, AND SYSTEM OF PROVIDING DRIVER STOPPING LOCATIONS FROM CROWD SOURCED DATA

(71) Applicant: HERE Global B.V., Eindhoven (NL)

(72) Inventor: James D. LYNCH, Waterloo, IA (US)

(21) Appl. No.: 18/999,865

(22) Filed: Dec. 23, 2024

(51) Int. Cl. G01C 21/00; B60W 60/00

(52) U.S. Cl. CPC G01C 21/3822; B60W 60/001; G01C 21/3881; B60W 2552/53

(57) ABSTRACT

An approach is provided for determining driver stopping locations from crowd sourced data. The approach, for instance, involves processing vehicle drive data to determine aggregated vehicle drive geometries. The approach also involves associating and clustering the aggregated vehicle drive geometries into vehicle drive path segments. The approach further involves joining the vehicle drive path segments in a drive path aggregation model using connectivity coherence of each vehicle drive path segment. The approach further involves aggregating stop data representing drives that stop within a specific range of the node, the segment, or a combination thereof of one or more vehicle drive path segments, and providing the stop data as an output.

### BACKGROUND

As vehicles gain more autonomous capabilities (e.g., highly assisted driving, fully or partially autonomous driving, etc.), service providers face significant technical challenges with respect to implementing these capabilities in a more “humanized” manner. For example, humanized driving in the context of autonomous or highly assisted vehicles refers to the implementation of driving capabilities that mimic human behavior and decision-making. The goal is to make autonomous driving feel more intuitive and comfortable for human passengers by incorporating real-world driving patterns and preferences into the vehicle's operating system. One of these preferences relate to where and when to make stops in a road network.

### SOME EXAMPLE EMBODIMENTS

Therefore, there is a need for an approach for determining natural stopping locations based on the actual driving behavior of many individuals (e.g., crowd sourced vehicle drive data), rather than relying solely on physical stop lines or other map features.

According to one embodiment, a method comprises processing vehicle drive data to determine a plurality of aggregated vehicle drive geometries. The vehicle drive is determined using one or more sensors of one or more vehicles. The method also comprises associating and clustering the plurality of aggregated vehicle drive geometries into a plurality of vehicle drive path segments. The method further comprises joining the plurality of vehicle drive path segments in a drive path aggregation model using connectivity coherence of each vehicle drive path segment of the plurality of vehicle drive path segments. Each vehicle drive path segment is represented by a node and a segment. The method further comprises aggregating stop data representing drives that stop within a specific range of the node, the segment, or a combination thereof of the one or more vehicle drive path segments for one or more vehicle drive path segments of the drive path aggregation model. The method further comprises providing the stop data as an output. In one embodiment, the stop data is further based on one or more conditions and/or attributes. By way of example, the one or more conditions or attributes include, but are not limited to, an absence or a presence of traffic in front of the one or more vehicles.

According to another embodiment, an apparatus comprises at least one processor, and at least one memory including computer program code for one or more computer programs, the at least one memory and the computer program code configured to, with the at least one processor, cause, at least in part, the apparatus to process vehicle drive data to determine a plurality of aggregated vehicle drive geometries. The vehicle drive is determined using one or more sensors of one or more vehicles. The apparatus is also caused to associate and cluster the plurality of aggregated vehicle drive geometries into a plurality of vehicle drive path segments. The apparatus is further caused to join the plurality of vehicle drive path segments in a drive path aggregation model using connectivity coherence of each vehicle drive path segment of the plurality of vehicle drive path segments. Each vehicle drive path segment is represented by a node and a segment. The apparatus is further caused to aggregate stop data representing drives that stop within a specific range of the node, the segment, or a combination thereof of the one or more vehicle drive path segments for one or more vehicle drive path segments of the drive path aggregation model. The apparatus is further caused to provide the stop data as an output. In one embodiment, the stop data is further based on one or more conditions and/or attributes. By way of example, the one or more conditions or attributes include, but are not limited to, an absence or a presence of traffic in front of the one or more vehicles.

According to another embodiment, a non-transitory computer-readable storage medium carries one or more sequences of one or more instructions which, when executed by one or more processors, cause, at least in part, an apparatus to process vehicle drive data to determine a plurality of aggregated vehicle drive geometries. The vehicle drive is determined using one or more sensors of one or more vehicles. The apparatus is also caused to associate and cluster the plurality of aggregated vehicle drive geometries into a plurality of vehicle drive path segments. The apparatus is further caused to join the plurality of vehicle drive path segments in a drive path aggregation model using connectivity coherence of each vehicle drive path segment of the plurality of vehicle drive path segments. Each vehicle drive path segment is represented by a node and a segment. The apparatus is further caused to aggregate stop data representing drives that stop within a specific range of the node, the segment, or a combination thereof of the one or more vehicle drive path segments for one or more vehicle drive path segments of the drive path aggregation model. The apparatus is further caused to provide the stop data as an output. In one embodiment, the stop data is further based on one or more conditions and/or attributes. By way of example, the one or more conditions or attributes include, but are not limited to, an absence or a presence of traffic in front of the one or more vehicles.

According to another embodiment, an apparatus comprises means for processing vehicle drive data to determine a plurality of aggregated vehicle drive geometries. The vehicle drive is determined using one or more sensors of one or more vehicles. The apparatus also comprises means for associating and clustering the plurality of aggregated vehicle drive geometries into a plurality of vehicle drive path segments. The apparatus further comprises means for joining the plurality of vehicle drive path segments in a drive path aggregation model using connectivity coherence of each vehicle drive path segment of the plurality of vehicle drive path segments. Each vehicle drive path segment is represented by a node and a segment. The apparatus further comprises means for aggregating stop data representing drives that stop within a specific range of the node, the segment, or a combination thereof of the one or more vehicle drive path segments for one or more vehicle drive path segments of the drive path aggregation model. The apparatus further comprises means for providing the stop data as an output. In one embodiment, the stop data is further based on one or more conditions and/or attributes. By way of example, the one or more conditions or attributes include, but are not limited to, an absence or a presence of traffic in front of the one or more vehicles.

In addition, for various example embodiments described herein, the following is applicable: a computer program product may be provided. For example, a computer program product comprising instructions which, when the program is executed by a computer, cause the computer to perform any one or any combination of methods (or processes) disclosed.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing driver stopping locations from crowd sourced data, according to one example embodiment;

FIG. 2 is a diagram of components of a mapping platform capable of providing driver stopping locations from crowd sourced data, according to one example embodiment;

FIG. 3 is a flowchart of a process for providing driver stopping locations from crowd sourced data, according to one example embodiment;

FIGS. 4A-4C are diagrams illustrating an example of aggregating and aligning individual vehicle drive paths for determining aggregated stopping behaviors, according to one example embodiment;

FIG. 5 is a diagram of source drives captured for each map tile, according to one example embodiment;

FIG. 6 is a flowchart of a process for aggregation alignment of source drives, according to one example embodiment;

FIGS. 7A-7C are diagrams illustrating an example of aggregating and aligning source drives based on feature detections, according to one example embodiment;

FIGS. 8A and 8B are diagrams illustrating examples of aggregated stopping locations, according to one example embodiment;

FIGS. 9A-9C are diagrams illustrating a closer view of source drives for determining aggregated stopping locations, according to one example embodiment;

FIG. 10 is a diagram of a geographic database, according to one embodiment;

FIG. 11 is a diagram of hardware that can be used to implement an embodiment of the invention;

FIG. 12 is a diagram of a chip set that can be used to implement an embodiment of the invention; and

FIG. 13 is a diagram of a mobile terminal that can be used to implement an embodiment of the invention.

### DESCRIPTION OF SOME EMBODIMENTS

Examples of a method, apparatus, and computer program for providing driver stopping locations from crowd sourced data, according to various example embodiments. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. In addition, the embodiments described herein are provided by example, and as such, “one embodiment” can also be used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

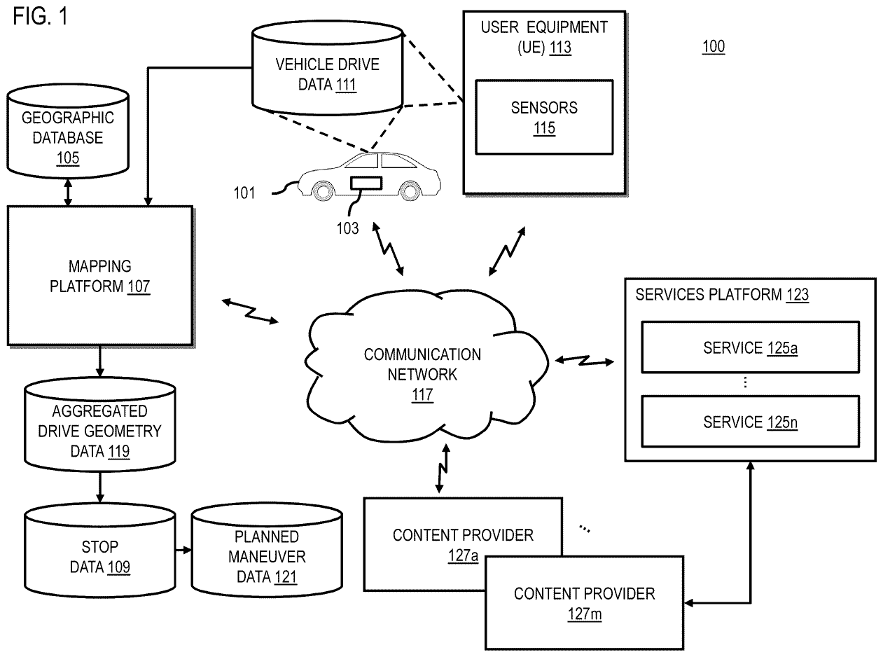

FIG. 1 is a diagram of a system capable of providing driver stopping locations from crowd sourced data, according to one example embodiment. For driver assistance or autonomous operation, a vehicle (e.g., a vehicle 101 via onboard systems 103) generally plans vehicle controls (e.g., stops) ahead of time and based on various situations (e.g., planned maneuvers, approaching intersections, etc.). The map (e.g., digital map data of a geographic database 105 available via a mapping platform 107) may contain a physical stop line to indicate where vehicles 101 are instructed to stop. However, there are many other stopping locations that an actual driver may need to undertake, such as stopping for on-coming traffic when making a turn maneuver. Also, physical stop lines may not exist for many required stop locations (especially in urban, residential areas). By aggregating the behavior where drivers most often stop, the map can provide a safer on-board vehicle maneuver planning.

To address the technical challenges associated with the above process, the system 100 of FIG. 1 introduces a capability to aggregate actual driver-based stopping behavior (e.g., stop data 109) by gathering real world sensor drive paths (e.g., vehicle drive data 111) from vehicles 101 and/or user equipment (UE) devices 113 via respective sensors 115 (e.g., positioning sensors such as Global Navigation Satellite System/Global Positioning System (GNSS/GPS)). In one embodiment, the vehicle drive data 111 can also include additional attributes collected by the sensors 115 and/or otherwise obtained from the vehicles 101 and/or UEs 113, such as but not limited to speed, day/night, turn signal, maneuver paths, etc. The aggregated paths and stopping locations are defined for each lane, and even for paths that may not be a specific lane (e.g., drivers may often change lanes near an off ramp, or cut a corner when turning). Different paths may be taken during different situations; such as a different path may be used for turning left, when there is on-coming traffic versus when no traffic is present. Therefore, in one embodiment, the system 100 may model a different stop location associated with different contextual attributes such as but not limited to (1) traffic present, (2) traffic not present, (3) day versus night, (4) if the vehicle 101 is just accelerating from being stopped at a traffic signal (slow approach), (5) and/or if the driver had a green light the entire time (fast approach).

In one embodiment, a stopping score may only consist of vehicle stops when traffic was not present in front of the vehicle (e.g., referred to herein as a virtual stop). In scenarios where traffic is present, such a stopping score (e.g., score using vehicle drive data 111 that indicates there is no traffic or traffic below a threshold value within a threshold proximity of the vehicle such as in front of the vehicle) may better provide an ideal stop location that is independent of vehicles that stopped due to traffic congestion. When a driver is free to stop at any locations, without external (other vehicles) restrictions, this may better define where a driver feels most comfortable stopping. In one embodiment, the term “traffic in front of the vehicle” indicates that traffic is present within a threshold proximity of the vehicle and/or that causes the vehicle to drive at a speed that is more than a threshold value below a free flow traffic speed, historical average speed, posted speed limit, and/or the like.

Essentially, the system 100 (e.g., via the mapping platform 107) creates various stop locations (e.g., stop data 109) that indicate where most drivers appear to stop, regardless of the map's physical features (e.g., in the middle of an intersection waiting for on-coming traffic). There may be multiple, different stop locations, based on different environmental and maneuver planning situations (e.g., traffic present/not present). The technical challenges are efficiency, alignment of drives, aggregation (e.g., clustering) of drive paths and stop behavior, and attaching this data (e.g., stop data 109) to the delivered map (e.g., digital map data of the geographic database 105).

In one embodiment, the aggregation is performed with at least lane-level accuracy, such that the stop locations may be different from each lane on a road.

In one embodiment, vehicles 101 and/or UEs 113 designed with sensor data capture collect drives (vehicle drive data 111) from a multitude of vehicles 101 (e.g., perhaps millions of drives a day). These drive paths can be anonymized by the vendor/source (e.g., an automotive original equipment manufacturer (OEM)), and delivered to mapping platform 107 for sensor aggregation, conflation, and derivation. With the result being a consensus of how an average driver may have behaved, given many drives at the same location. In some embodiments, the mapping platform 107 can aggregate vehicle drive data 111 directly from vehicles 101 over a communication network 117.

By way of example, the vehicle drive data 111 can include vehicles drives or source drives that represent vehicle trajectory data collected by the sensors of the vehicles 101 and/or UEs 113. Vehicle trajectory data is a type of data that records the location, direction, speed, and/or time of a vehicle as it moves over a road network. Some examples of vehicle trajectory data include but are not limited to: (1) a sequence of latitude and longitude coordinates that indicate the position of a vehicle at different timestamps; (2) a polyline that shows the shape and direction of a vehicle path on a map; (3) a set of attributes that describe the speed, duration, frequency, or events of a vehicle movement along a path; and/or (4) any other equivalent data. The vehicle drives can also include detections of features (e.g., road signs, poles, lane markings, road furniture, on-road objects, objects within detection range of the road, etc.) that are present on or within proximity of the road on which the vehicle 101 is driving.

Source drives (e.g., vehicle drive data 111 can be processed by the mapping platform 107 using cloud-based streaming processing or equivalent on a map tile-by-tile basis. For example, typically processing a large number of drives for each world Tile (e.g., Earth is subdivided into tiles at various scales—e.g., smaller and smaller tiles). Initially, each drive, can be fitted with a Kalman filter to create a smooth vehicle path that follows both the relative motion of the vehicle 101 and the GNSS or other positioning observations.

However, based on GNSS accuracy, the resulting drives may not be high enough accuracy to determine lane level alignment. Therefore, in one embodiment, for each tile, all the drives are aligned to each other by optimizing the alignment of many different observations, such as signs, poles, lane markings, etc.

The result is that the multitude of drives overlap, with enough accuracy, that the system 100 can aggregate the drive paths that overlap with enough certainty, such that the system 100 may model behavior-based drive path geometry (e.g., aggregated vehicle drive geometry data 119). The geometry data 119 may be defined differently for different maneuvers (e.g., lane changes, intersection turns, merge, split, behavioral speed, etc.)

With the aggregated vehicle drive geometry data 119 defined, the system 100 has an association of each drive path node and segment, along with which drives contributed to each node and segment. The system 100 then gathers the various driver behavior (e.g., stops, speeds, maneuvers, etc.), and models statistics such as average, mean, minimum, maximum, standard deviation (StdDev), etc.) of the behavior for each segment. For stopping locations, the system 100 can aggregate the average speed driven for each drive path to determine where the average speed is below a threshold speed for classification as a stop.

The system 100 can aggregate how many of the drives stop on each segment; indicating the percentage of drives that stopped within a certain range of each node/segment. For example, if there are 500 drives that traversed the same location in the lane, and 20 of them stopped within X meters (or any other threshold proximity) of the node; the system 100 may assign a Stopping-Rate of 20/500 (e.g., indicating that 20 of 500 drives stop at this location).

In one embodiment, the system 100 also qualifies different stop location criteria based on one or more attributes, such as stop when no other traffic is present (e.g., a stop that is not due to slow traffic), stop locations when a maneuver is performed in an intersection, stop location at night versus daytime, and/or the like. For example, a vendor source may already indicate stop locations where there were no forward vehicles that blocked the path of the sensor collection vehicle (e.g., may be called a virtual stop location). As described above, in one embodiment, the stop locations are determined based on vehicle drive data associated contextual information or attributes that indicates that the vehicle is operating without traffic present in front of the vehicle. The advantageously provides the capability to determine stop locations that are not caused by a vehicle stopping due to traffic but stopping to do other non-traffic related conditions (e.g., upcoming turn). For example, the presence of traffic can be determined using traffic information collected and stored in the geographic database 105 for a location/road link at a time period or epoch corresponding to the location and time that the vehicle drive data was collected. In other embodiments, the presence of traffic can be determined using onboard sensors (e.g., cameras, LiDAR, and/or the like) of the vehicle and reported with its corresponding vehicle drive data. In another embodiment, the presence of traffic can be determined based on determining whether the reporting vehicle's speed is more than a threshold value below a speed threshold (e.g., a free flow speed, average speed, speed limit, etc. for the given location/road link). It is noted that the above examples of determining the presence of traffic in front of a vehicle is provided by way of illustration and not as limitations. Accordingly, it is contemplated that any equivalent mechanism, process, means, etc. of determining the presence of traffic in front of a vehicle can be used according to the various embodiments described herein.

In summary, the various embodiments of the system 100 described herein provide for aggregation of crowd sourced vehicle sensor data (e.g., vehicle drive data 111) to model stopping locations based on driven behavior of many individual drives; such that a model of where the most likely stop locations (e.g., stop data 109) can be created. As opposed to mapping physical stop-lines, the system 100 models stop locations based on actual driven stops. These stop locations can also be correlated with various contextual attributes, for example, stop locations when making a turn maneuver, with or without a physical stop line, etc. The system 100 involves capturing a large volume of actual drives (e.g., sensor data collected from potential thousands, hundreds of thousands, or even millions of drives per day), aligning the drives to remove position uncertainty, and capturing multiple drive pass at a lane-based (sub-meter) overlap of multiple drives. Then aggregating drive paths (e.g., aggregated vehicle drive geometry data 119), and finally aggregating stopping behavior from all overlapping drives (e.g., stop data 109).

The aggregated stop location may be attached to an on-board map (e.g., digital map data of the geographic database 105), such that vehicles 101 using such a map may make decisions ahead of time for where the best location is to stop (e.g., planned maneuver data 121). Different stop locations may be based on a multitude of behavior criteria, such as when turning left, turning right, when there are other vehicles ahead of the vehicle, when there is on-coming traffic, when there are parked cars on the road, etc.

In one embodiment, the stop data 109 and/or planned maneuver data 121 can be provided as an output from the mapping platform 107 and/or any other equivalent component of the system performing equivalent functionality. The output (e.g., stop data 109 and/or planned maneuver data 121) can be stored as an attribute of corresponding locations represented in the digital map of the geographic database 105. In addition or alternatively, the output can be provided or otherwise made accessible to a services platform 123, one or more services 125a-125n (also collectively referred to as services 125), and/or one or more content providers 127a-127m (also collectively referred to as content providers 127). By way of example, the services platform 123, services 125, and/or content providers 127 can be location-based services (e.g., mapping service, navigation service, autonomous driving services, vehicle assist services, etc.) that can use the output (e.g., stop data 109 and/or planned maneuver data 121) to perform one or more functions.

The various embodiments described herein for provide for several technical advantages including but not limited to:
(1) Using alignment, Lane level stop locations are possible, where each lane may have a different stop location. Each different maneuver may also have different stop locations.
(2) The determined stop locations are behavior based, such that the system 100 may provide a stop location, even when physical stop lines (or any other map feature indicating a stop such as but not limited to a stop sign, crosswalk, etc.) are not present.
(3) Stop locations in the middle of intersections may be detected, e.g., when waiting for traffic, signals, etc.
(4) Stop locations may be defined for different on-board situations, such as day/night, traffic present, specific turn maneuvers (e.g., turning left or right).
(5) Stop maneuvers may either be defined as a probability/likelihood along the path, or a specific, highest probability (point) location.
(6) The stop data 109 can be used to assist on-board (e.g., assisted/autonomous driving) maneuver planning (e.g., planned maneuver data 121), such that the stop locations (and speed deceleration) may be planned a head of the stop location, or when the stop location is unclear (e.g., rural roads).

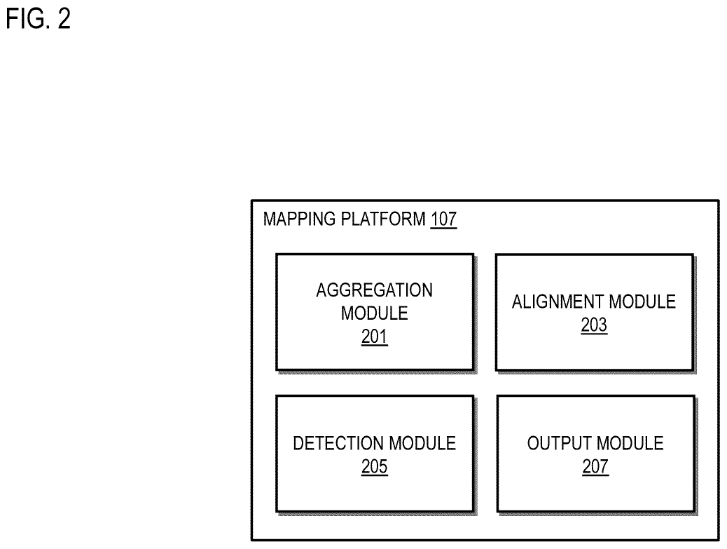

FIG. 2 is a diagram of components 201-207 of a mapping platform 107 capable of providing driver stopping locations from crowd sourced data, according to one example embodiment. As shown, the mapping platform 107 includes one or more components for providing driver stopping locations from crowd sourced data according to the various example embodiments described herein. In one example embodiment, the mapping platform 107 includes an aggregation module 201, an alignment module 203, a detection module 205, and an output module 207. The above presented modules and components of the mapping platform 107 can be implemented in hardware, firmware, software, circuitry, or a combination thereof. Though depicted as a separate entity in FIG. 1, it is contemplated that the mapping platform 107 may be implemented as a module of any of the components of the system 100 (e.g., a component of the services platform 123, services 125, content providers 127, vehicle 101, UE 113, and/or the like). In another embodiment, one or more of the modules 201-207 may be implemented as a cloud-based service, local service, native application, circuitry, or combination thereof. The functions of the mapping platform 107 and modules 201-207 are discussed with respect to the figures discussed below.

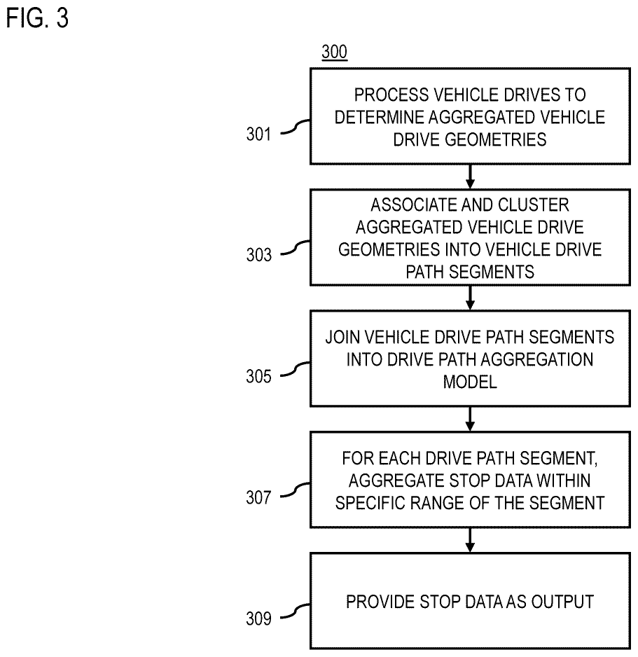

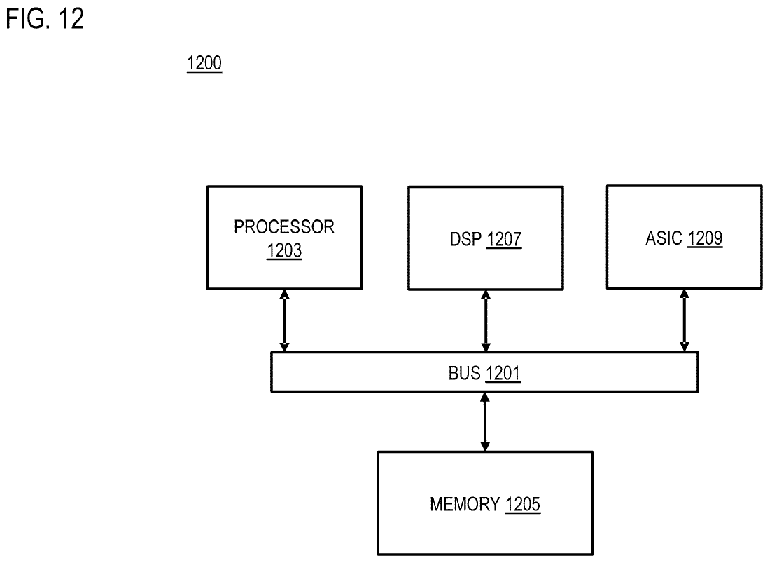

FIG. 3 is a flowchart of a process 300 for providing driver stopping locations from crowd sourced data, according to one example embodiment. In various embodiments, the mapping platform 107 and/or any of the modules 201-207 may perform one or more portions of the process 300 and may be implemented in, for instance, a chip set including a processor and a memory as shown in FIG. 12. As such, the mapping platform 107 and/or any of the modules 201-207 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

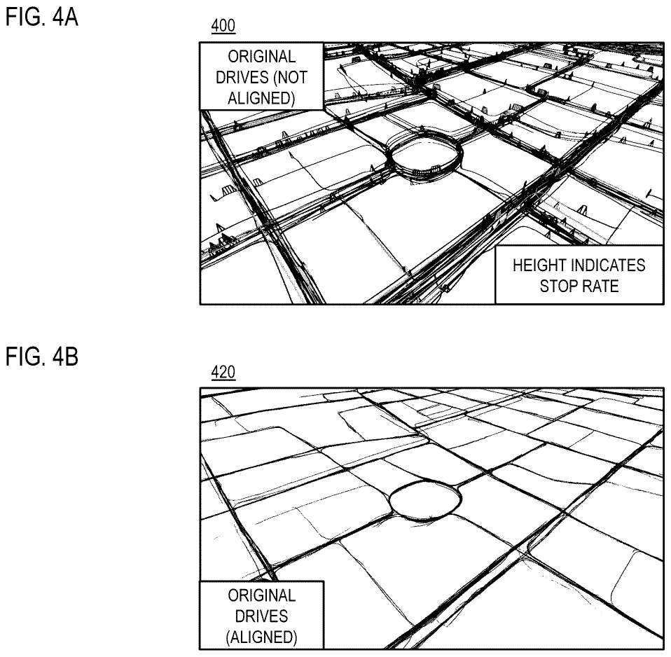

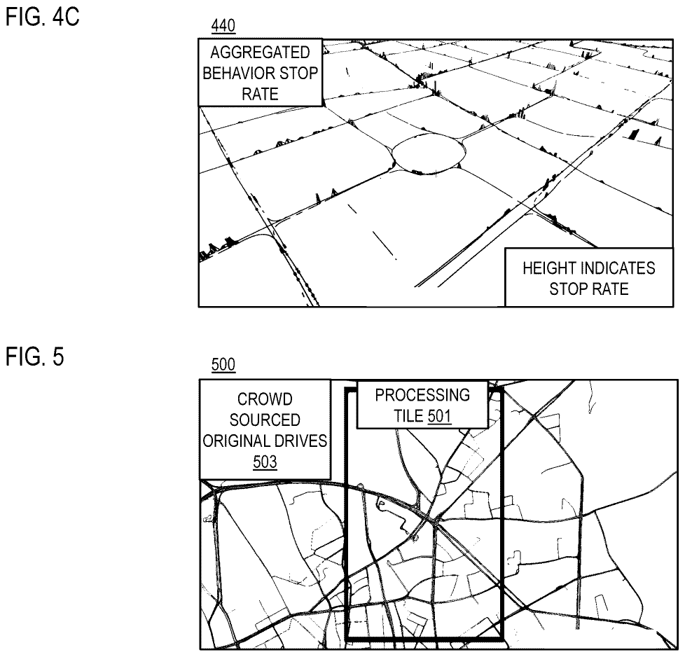

As an overview, one goal of the process 300 is to gather crowd sourced sensor drives, and aggregate average speeds along each potential drive path (e.g., to create a speed profile and/or stopping locations). FIG. 4A illustrates an example 400 of individual source drives (e.g., indicated by each separate line) without alignment and showing stop locations of individual drives (e.g., indicated by height along each drive path). Because the example 400 is shown without alignment, individual drives can be seen to be offset slightly in the horizontal and vertical planes because of inherent errors in the positioning technology used to capture each drive (e.g., GNSS). As a result stop locations (even if at the same locations) are also offset from each other.

For contrast, FIG. 4B illustrates and example 420 after the source drives are aligned (e.g., using the recursive alignment processed described further below). In example 420, the lines representing individual drives are more aligned such that each drive has less offset from each other. The alignment enables the offset to be less than a lane width so that lane-level analysis for stop locations can be performed as shown in FIG. 4C. FIG. 4C illustrates an example 440 of aggregated drive paths after alignment with aggregated stopping behavior rates indicated by height with a greater height indicating a greater stopping rate (e.g., expressed as number of cars that stop at a given location over the total number of cars that stop at or pass through the location).

The process 300 then aggregates stopping locations at the lane, maneuver, and condition level. With this aggregated stop scores, a future driven (assisted/automated/advised) vehicle 101 may have advanced knowledge of where the vehicle is expected to stop, where to slow down for before a stop, etc. Although a map may provide existing physical stop line locations,, the behavior stop scores (e.g., based on observed stops in the vehicle drive data 111) (1) provides expected stop locations when physical stop lines are not present; and/or (2) defines different stop locations for different lanes. In one embodiment, different stop location scores also may be defined for different maneuvers, within intersections, at split/merge points, or different conditions, such as day versus night, traffic versus no traffic, etc.

The following steps provide more detail of the process 300.

In step 301, the aggregation module 201 processes vehicle drive data 111 to determine a plurality of aggregated vehicle drive geometries (e.g., aggregated vehicle drive geometry data 119). The vehicle drive data 111 is determined using one or more sensors 115 of one or more vehicles 101 and/or UEs 113. In one embodiment, the vehicle drive data 111 can be collected from one or more data sources. One example data includes but is not limited to personal vehicles 101. For example, personal vehicles 101 from certain vendors (e.g., OEMs) contain on-board sensors 115 that track a vehicles path and speed, and track objects or features along the road, such as but not limited to signs, poles, road markings, lane marking, road boundary, traffic signals, other traffic, turn signals, lane crossing, and various environmental situations. Millions of these drives are uploaded to the cloud and ingested into the cloud processing system of the mapping platform 107. These are referred to herein crowd sourced sensor drives.

The drives are assigned into corresponding map tiles (e.g., Level 14 subdivision a standard map tile representation of the Earth) which are about 2 km×2 km and are continuously collected over a specific range of dates. Each tile may contain thousands of drives or more. The package of tile drives is delivered to the aggregation module 201 of the mapping platform 107 processing stream. FIG. 5 is a diagram 500 of source drives captured for an example map tile 501, according to one example embodiment. In this example, the area of the map tile 501 is used to divide the crowd sourced original drives 503 (e.g., a collection of multiple drives captured from vehicles traveling over the road network in the geographic area of interest) in units for separate processing to determine stop locations within map tile 501. This can provide for greater efficiency of processing by subdividing the crowd sourced original drives 503 is smaller units that can be processed individually or in parallel.

In step 303, the alignment module 203 associates and clusters the plurality of aggregated vehicle drive geometries into a plurality of vehicle drive path segments. The step, for instance, is referred to as aggregation. In one embodiment, the tile (e.g., map tile 501) of drives is processed as a group in the aggregation process, which reduces the data into an aggregate, or consensus of how all the drives see a single model. For example, if there are 500 drives that traverse the same lane, at the same point, the aggregated output is one point. This aggregated point contains the consolidated attributes of all the drives, such as the where stops occur, and average speed of all the drives at the point along the lane path. Likewise, all other contextual attributes, such as but not limited to date, day-night, construction, maneuver type, etc. are aggregated as well. In addition, all detected features associated with the drives such as but not limited to the signs, poles, lane-markings, etc. are also aggregated into a single representation of the consensus of all drives. Noise, or outliers, may be removed if observations are not consistent, or randomly observed.

The aggregation may occur without the aid of existing data; such that only the incoming crowd-sourced drive information is used, without any bias to a pre-existing map (e.g., geographic database 105). In other cases, a pre-existing map (e.g., geographic database 105) may be used to assist association.

One goal of aggregation is to gather information about the same object or same behavior from each drive. The challenge is to determine which features from one drive are associated with the same feature of another drive. If the system 100 has perfect data (e.g., perfectly accurate drive locations and feature detection locations), this might be straight forward. However, there are always sensor noise and uncertainty, such as geo-location accuracy, false sensor readings, sensor uncertainty, adverse environmental conditions (e.g., blocked view due to traffic or weather), and/or the like. There may be many of the same real-world features (e.g., similar signs) in the same location, such that the sensor uncertainty may be larger than the distance between the real-world features. With this uncertainty, correct association between different drives may not be possible. For example, if the GNSS geo-location is only precise to 5m, the aggregation module 201 might not be able to associate drives into the correct lane. In addition, for drives paths, there is not a single physical drive path, and each drive may take slightly different trajectory, such that association many be challenging.

In one embodiment, to assist in aggregation, the alignment module 203 can perform an aggregation alignment of a plurality of vehicle drives in the vehicle drive data based on one or more features detected during the plurality of vehicle drives by the one or more sensors of the one or more vehicles. One step to making correct associations between different drives is to reduce the drive path uncertainty. Since sensor data may have significant positional and detection uncertainty, the drives in the tile are first aligned using detected features (e.g., physical objects, such as but not limited to signs, poles, lane-markings, etc.).

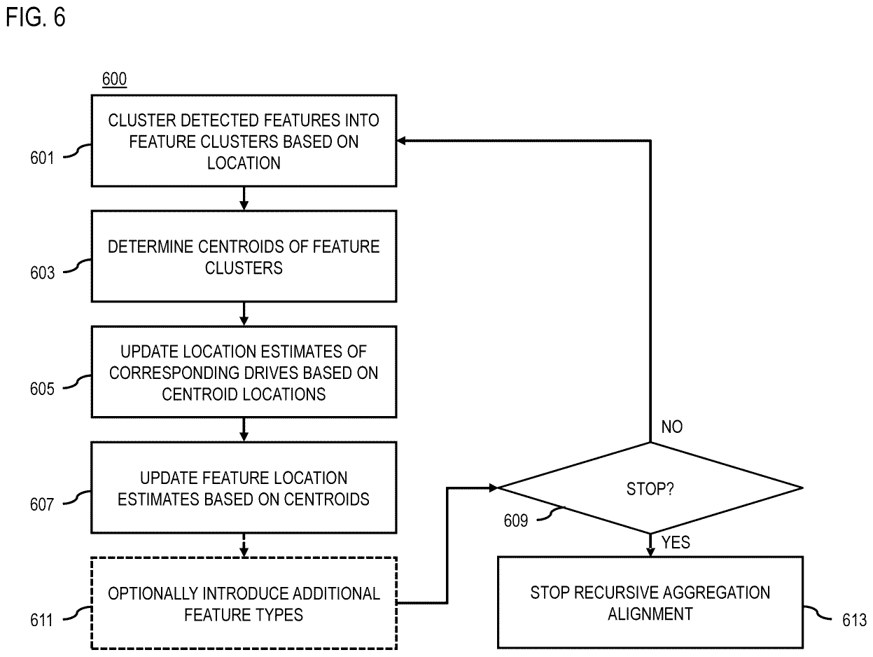

An iterative approach of association, clustering, and alignment is performed. An example of this iterative approach is shown in FIG. 6 which is a flowchart of a process for aggregation alignment of source drives, according to one example embodiment. In various embodiments, the mapping platform 107 and/or any of the modules 201-207 may perform one or more portions of the process 600 and may be implemented in, for instance, a chip set including a processor and a memory as shown in FIG. 12. As such, the mapping platform 107 and/or any of the modules 201-207 can provide means for accomplishing various parts of the process 600, as well as means for accomplishing embodiments of other processes described herein in conjunction with other components of the system 100. Although the process 600 is illustrated and described as a sequence of steps, it is contemplated that various embodiments of the process 600 may be performed in any order or combination and need not include all of the illustrated steps.

In step 601, the alignment module 203 clusters the one or more detected features into one or more feature clusters based on one or more feature geo-location estimates of the one or more detected features. For example, the alignment module 203 first uses the provided geo-location estimate of the paths (e.g., Kalman fused global GNSS and relative motion), and all the detected features (e.g., poles, signs, etc.) are attached to the initial estimate. In one embodiment, the clustering of the one or more detected features is further based on or more attributes (e.g., shape, size, color, etc.) of the one or more detected features. Typically, each feature (e.g., sign, poles, etc.) are attached to the drive paths, such that an update to the drive path, also updates the position of each attached feature. The alignment module 203 then associate non-ambiguous (e.g., standalone signs, without neighbors, high confidence observations only) between drives, cluster these associations, and aggregate the multiple drive observations into a single consensus of the feature. For example, the one or more detected features are features that are classified as non-ambiguous based on (1) the one or more detected features being a standalone feature with no other feature being detected within a threshold proximity, or (2) the one or more detected features having a feature detection confidence above a threshold confidence

In step 603, the alignment module 203 determines respective one or more centroids of the one or more feature clusters. More specifically, the centroid location of the aggregated feature is used to estimate how each individual drive would need to move to align with the centroid. This is performed for all non-ambiguous features (poles, signs, signals, etc.). Given all the estimated path alterations, a new, entire, drive path is optimally modeled for each drive. In one embodiment, the associations are based on as many attributes as possible, not just geo-location. For example, a sign's width and height, sign type, sign, shape, sign heading, etc. may all be used to help associate each drive's features with the same physical features in other drives.

In step 605, the alignment module 203 updates geo-location estimates of one or more corresponding drives of the plurality of vehicle drives based on the one or more centroid geo-locations of the respective one or more centroids. For example, the alignment module 203 can determine the difference between the centroid location of a given feature and the geo-location estimate of the same feature in a drive. The difference between the two locations (e.g., in the x, y, and z axes) can be applied to adjust the geo-location estimates of each point in the drive being evaluated.

In step 607, the alignment module 203 also updates the one or more feature geo-location estimates based on the one or more centroid geo-locations. For example, after each iteration, the alignment module 203 recomputes new feature locations for all the detected features (e.g., signs, poles, etc.) as defined by the path updates. The alignment module 203 then iterates this procedure (step 609), with the expectation that each iteration provides better alignment, such that the features that were previously ambiguous (using the original paths), may now be associated correctly with the improved paths.

Eventually, more features (such as lane-markings) are introduced to refine the path alignments (step 611). For example, one or more additional detected feature types or features (e.g., lane markings) are introduced after completing a designated number of recursions of the aggregation alignment. Each iteration pass includes an incremental count of available features, until we have a semi-optimal path for every drive (e.g., stop condition is reached such as achieving lane level alignment accuracy of 5 m or better), such that the common features between drive align. In step 613, once the stop condition is met, then the alignment module 203 stops the recursive aggregation alignment. For example, the aggregation alignment is iterated recursively until a threshold number of available features align between the one or more corresponding drives.

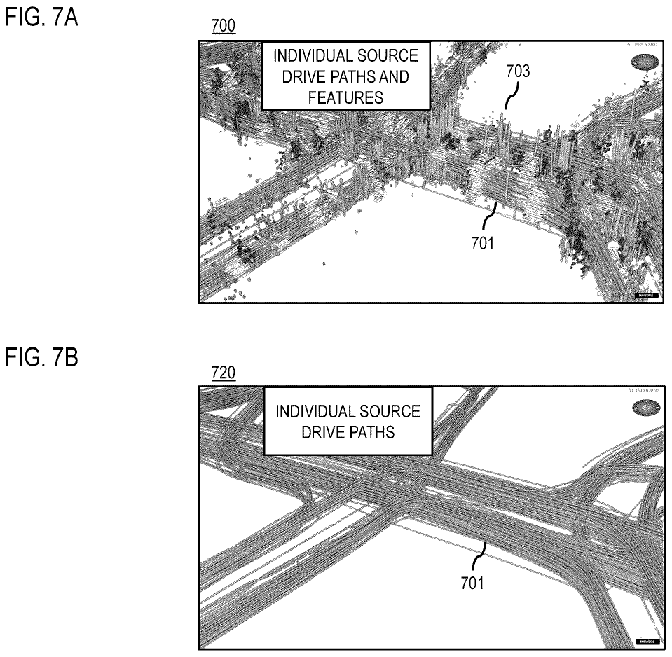

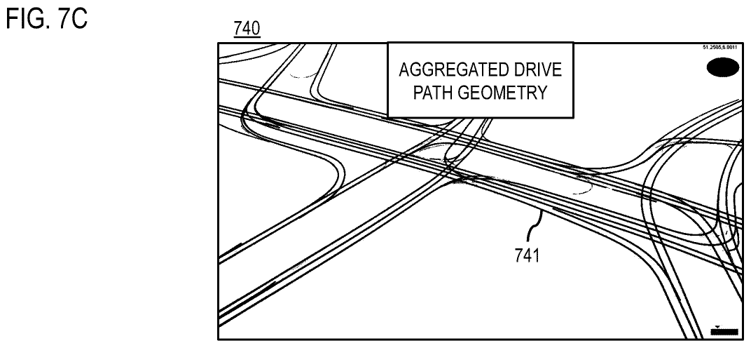

One example embodiment of the alignment process is summarized as follows:
(1) Association=Compare geolocation proximity, width/heigh dimension match, sign/pole type match, shape match, heading match. As previously described, the associating of the aggregated vehicle drive geometries can be by associating a proximity, a heading, a future maneuver, a past maneuver, or a combination thereof the one or more vehicles. The alignment module 203 applies a new association for every pass. FIG. 7A illustrates an example 700 of original sensor drives with feature detections, according to one example embodiment. In the example 700, example raw individual source drive paths 701 and feature detections 703 (e.g., a detected pole) are shown. To contrast against the feature detections 703, FIG. 7B illustrates an example 720 that removes the feature detections 703 and shows only the individual source drive paths 701.
(2) Clustering=Use Association to group each drive observations of the same physical feature (e.g., pole feature 703 of FIG. 7A). Compute the centroid consensus. This centroid consensus location is now the goal for each drive to achieve for the location of this feature.
(3) Iteration=Apply steps 1 and 2 for all features in the tile, and for all drives.
(4) Choose which clusters are non-ambiguous (e.g., high confidence that association is correct), and ignore all others.
(5) Recompute each drive (full drive) such that the new drive path's features optimally match the clustered centroids.
(6) Update all feature locations of each drive, given the new drive paths.
(7) Inject additional refinement features, such as lane markings (we need to wait for several passes, until alignment is good enough to correctly associate close together lane-markings)
(8) Repeat steps 1-7.

This aggregation alignment process 600 results in an aggregated vehicle drive path geometry with drives optimally aligned. FIG. 7C illustrates an example 740 of an aligned aggregated drive path geometry 741. For example, this aligned aggregated drive path geometry 741 (e.g., aligned using drive features, such as sign and poles) can now be used to distinguish lane level association. As previously described the aggregated drive path geometry 741 is a single representation (e.g., a node segment representation with the nodes every designated distance, at intersections, etc.) of the drive paths aggregated to create the geometry 741.

Next, process 600 returns to the process 300 of FIG. 3 to perform further association, cluttering, and aggregation of drive path geometry and stop rate attribution. For example, now that the drive paths (and attached features) are spatially aligned relative to each other, the alignment module 203 can now associate features between drives. In this case, one goal is the association of overlapping drive path segments between drives. The alignment module 203 applies a similar association and cluster as the above alignment passes. However, the alignment module 203 clusters all the attributes attached to each drive path node/segment, such as stops locations and speed. In addition, the association is more complex for drive path association, since the alignment module 203 has to take into account different maneuvers and trajectories, not just spatial proximity. For example, the alignment module 203 may not want to aggregate drives that are about to perform a turn maneuver, with other drives that are continuing straight along the road, even if the paths overlap spatially. The drives that are about to turn may have the same spatial proximity to the straight paths; however, the drives performing the turn may have different stop locations than the straight drives. Therefore, in one embodiment, the alignment module 203 only associates drive sections if they followed the same maneuver. For example, the alignment module 203 can check where the drive was 50 m before and 50 m after (or any other designated distance threshold before or after) the focused segment. In order for other drive segments to associate this segment, the alignment module 203 checks that the other drives segments match in heading and spatial proximity, and also that the past and future location (e.g., 50 m behind, and ahead, or any other designated distance threshold), also match. In this way, the alignment module 203 can match only drives with the same maneuver pattern. Similarly, the alignment module 203 can be configured to prevent lane change maneuvers from associating with non-lane changes; such that the alignment module 203 may model stopping scores with or without lane change maneuvers from affecting the aggregated stop scores.

In step 305, the alignment module 203 joins the plurality of vehicle drive path segments in a drive path aggregation model using connectivity coherence of each vehicle drive path segment of the plurality of vehicle drive path segments, wherein each vehicle drive path segment is represented by a node and a segment. In one embodiment, the alignment module 203 first associates and cluster drive path geometries, by associating on both proximity, heading, and future/past maneuvers. These clusters are created at a short segment level (e.g., any designated distance interval such as 1 m, 5 m, 10 m, etc.), with connectivity preserved, then joined together into continuous paths using the connectivity coherence of each drive. The result is a drive path aggregation model of the physical average drive paths.

This aggregated drive path geometry is the basis for determining behavior stopping locations. Each aggregated drive node and segment now contains a reference to each individual drive that was associated with the node/segment.

In step 307, the detection module 205, for one or more vehicle drive path segments of the drive path aggregation model, aggregating stop data representing drives that stop within a specific range of the node, the segment, or a combination thereof of the one or more vehicle drive path segments. In other words, for each node/segment, the detection module 205 gathers the set of attributes from all the associated drives and generate and average of the attributes. Mainly, the detection module 205 aggregates the count and ratio of drives that stop withing a specific range of the node/segment. In addition or alternatively, the stop data 109 can be based on a probability of the drives that stop within the specific range. Accordingly, the stop data 109 can be based on a count, a ratio, a stop probability, or a combination thereof of the drives that stop within the specific range. As used herein, “specific range” refers to a discrete interval of distance along the segment. For example, a segment can be divided based on fixed distance intervals (e.g., 1 m intervals, 5 m intervals, etc.), and each interval can be referred to as a specific range. In addition, the detection module 205 also aggregates all the other attributes, such as date range, environment conditions (traffic present, day-night), maneuver type (lane change, intersection turn). In other words, the aggregated vehicle drive geometries are aggregated based on one or more contextual attributes of the one or more vehicles, one or more maneuvers performed by the one or more vehicles, one or more drives performed by the one or more vehicles, one or more environments in which the one or more drives are performed, or a combination thereof. The detection module 205 may aggregate different stop rates, based on certain criteria. For example, the detection module 205 may aggregate stop only from associated drives that were not limited by traffic congestion, or only count drives where the vehicle stopped within 50 m (e.g., ignore vehicles that do not stop when a traffic signal was always seen as green) or aggregate a separate stopping rates for day versus night.

Finally, the detection module 205 has a set of aggregated drive path geometries, with varying rates of stops-per-per drive, along each node of each path. These are the behavior stop rates and may be used to apply a stop probability along each map lane line. In addition or alternatively, a single highest probability may be used to model a single specific point with the highest probability of a stop. These probabilities may be used on-board vehicles to plan ahead of time, an expectation of where the vehicle is likely to stop, such that the vehicle may make speed adjustments, risk adjustments, plan specific stop points, and/or the like.

In step 309, the output module 207 provides the stop data as an output. In one embodiment, the output is provided as data for planning at least one stop location of a vehicle as discussed above. In another embodiment, the output can be captured into a behavior drive model, and delivered to further stream processes of the mapping platform 107 that may align this data to other sources, other maps, may conflate (join/mix) this behavior model with other sources, and finally derive a customer facing map which contains the driver behavior with associated map links.

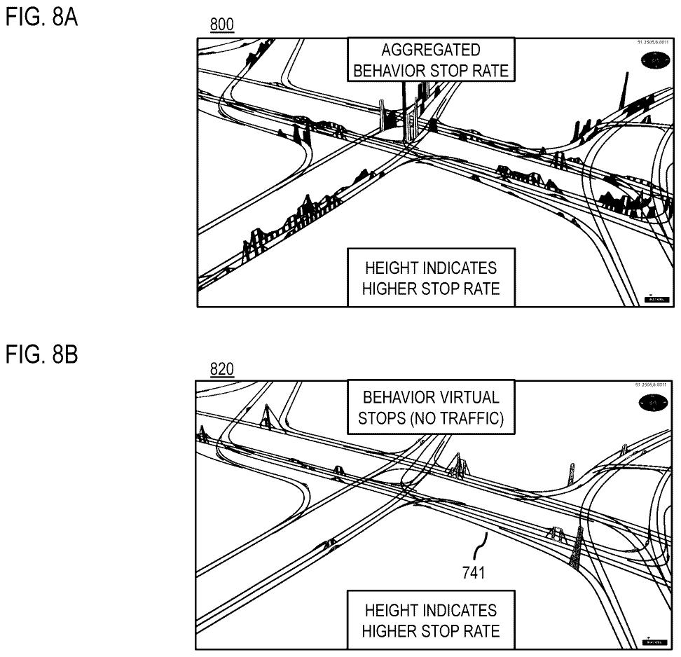

FIG. 8A illustrates an example 800 of aggregated stopping locations/behavior stop rates for the aggregated drive path geometry illustrated in example 740 of FIG. 7C. In this example, the stop rate at any location is represented by the height of the line above the road with higher lines indicating higher stop rates. As previously discussed, in one embodiment, the stop rate indicates the ratio of drives that stop within any specific region or location on the road. In this example, the stop rates are lane and maneuver based (e.g., the stop rates are computed based on drives in a particular lane or when a vehicle is performing a particular maneuver).

In other embodiments, the stop rates can be based on other contextual attributes such as the presence or absence of traffic. FIG. 8B illustrates an example 820 of aggregated behavior stopping locations/behavior stop rates when no traffic is present in front of the vehicle. This represents stops independent of stopping due to traffic congestion.

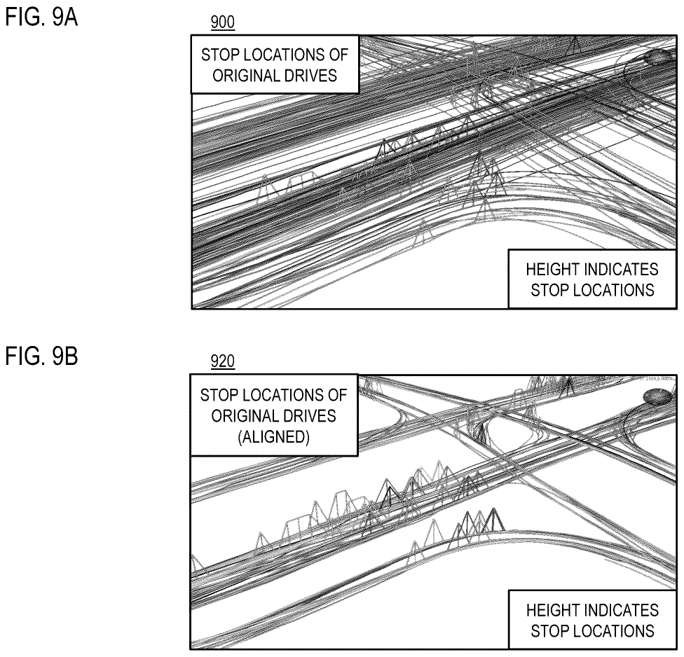

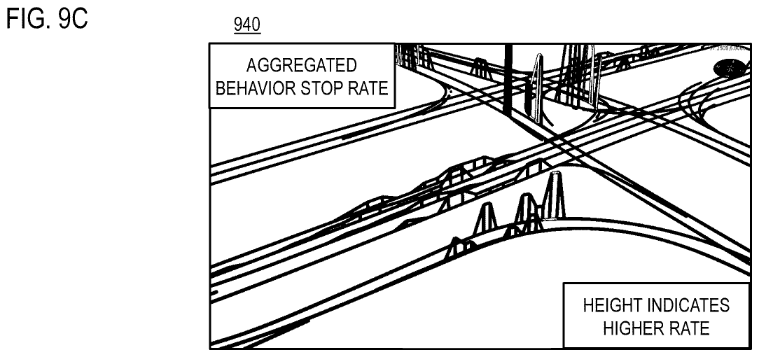

FIGS. 9A-9C are diagrams illustrating a closer view of source drives for determining aggregated stopping locations, according to one example embodiment. More specifically, FIG. 9A is a diagram of an example 900 of a closer view, showing original drives. Each line represents a different drive, and stops are indicated as spikes above the road. The stop locations are generally specific points, with a gaussian distribution, but shown here as a spike for simplicity. FIG. 9B is a diagram of an example 920 in which the drives in example 900 have been aligned (e.g., using observed features such as but not limited to signs, poles, etc.). In the aligned example 920 drives corresponding to individual lanes are discernible. FIG. 9C is a diagram of an example 940 that presents aggregated stop rates along each aggregated drive path. In this example the height above the road indicates the behavior stop rate of vehicles that stop along each node/segment of the aggregated drive path.

In one embodiment, stop data 109, including stopping locations and rates, can be used by assisted or autonomous driving systems to plan a vehicle. 101's upcoming maneuvers in a way that mimics human drivers. For example, a vehicle 101 can anticipate stops even when physical stop signs or lines are absent. This is because the stop data 109 is based on actual driver behavior, as captured by sensors on a large number of vehicles. The system 100 uses this data to create a probabilistic model of where vehicles are likely to stop, and this model can be used to adjust the vehicle 101's speed and prepare for stopping maneuvers in advance. The stop data 109 can also be used to differentiate between stops needed for different driving maneuvers, such as turning left, turning right, or encountering oncoming traffic. The system 100 can recognize the upcoming maneuver and plan the vehicle 101's stopping behavior accordingly. This results in smoother and safer navigation. Additionally, because the system 100 achieves lane-level accuracy for stop locations, it knows which lane's stop data is relevant to its current position, even on multi-lane roads. This can be used for autonomous lane changes and merging maneuvers. Finally, the system 100 considers contextual attributes or factors like time of day, traffic conditions, and the presence of parked cars to make human-like driving decisions. For example, the system 100 can aggregate a separate stop rate for driving at night versus during the day.

Returning to FIG. 1, as shown and discussed above, the system 100 includes the mapping platform 107 for providing driver stopping locations from crowd sourced data. In one embodiment, the mapping platform 107 has connectivity or access to one or more databases for storing the stop data 109, aggregated driver geometry data 119, and planned maneuver data 121 determined according to the various embodiments described herein, and as well as a geographic database 105 for retrieving mapping data and/or related attributes for map matching (or storing attributes related to the stop data 109, aggregated driver geometry data 119, and planned maneuver data 121). In one embodiment, the mapping platform 107 has connectivity over a communication network 117 to the services platform 123 that provides one or more services 125. By way of example, the services 125 may be third-party services that rely on location-based services created or developed based on the stop data 109, aggregated driver geometry data 119, and planned maneuver data 121, etc. generated according to the various embodiments described herein. By way of example, the services 125 include, but are not limited to, autonomous/semi-autonomous vehicle operation, mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 125 uses the output of the mapping platform 107.

In one embodiment, the mapping platform 107 may be a platform with multiple interconnected components. The mapping platform 107 may include multiple servers, intelligent networking devices, computing devices, components, and corresponding software for automated detection and/or characterization of road intersections. In addition, it is noted that the mapping platform 107 may be a separate entity of the system 100, a part of the one or more services 125, a part of the services platform 123, or included within the vehicles 101 and/or UEs 113.

In one embodiment, content providers 127 may provide content or data (e.g., including geographic data, vehicle drive data, vehicle path network data, etc.) to the mapping platform 107, the services platform 123, the services 125, and/or the vehicles 101. The content provided may also include any type of content, lane level road topology data, sensor data, map content, textual content, audio content, video content, image content, etc. used for map matching. In one embodiment, the content providers 127 may also store content associated with the mapping platform 107, geographic database 105, services platform 123, services 125, and/or vehicle 101. In another embodiment, the content providers 127 may manage access to a central repository of data, and offer a consistent, standard interface to data, such as a repository of the geographic database 105.

In one optional embodiment, the vehicles 101 and/or UEs 113 are configured with various sensors 115 for generating or collecting sensor observations (e.g., for processing by the mapping platform 107), related geographic data, etc. In one embodiment, the sensed data represents sensor data associated with a geographic location or coordinates at which the sensor data was collected to provide vehicle drive data 111. By way of example, the sensors 115 may include a global positioning sensor for gathering location data (e.g., GNSS/GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road boundaries, road sign information, images of road obstructions, etc. for analysis), LiDAR, radar, an audio recorder for gathering audio data, velocity sensors mounted on steering wheels of the vehicles, switch sensors for determining whether one or more vehicle switches are engaged, and the like.

In another optional embodiment, the communication network 117 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), 5G New Radio Networks, Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 107, services platform 123, services 125, vehicle 101, UE 113, and/or content providers 127 optionally communicate with each other and other components of the system 100 using well known, new or still developing protocols. In this context, a protocol includes a set of rules defining how the network nodes within the communication network 117 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

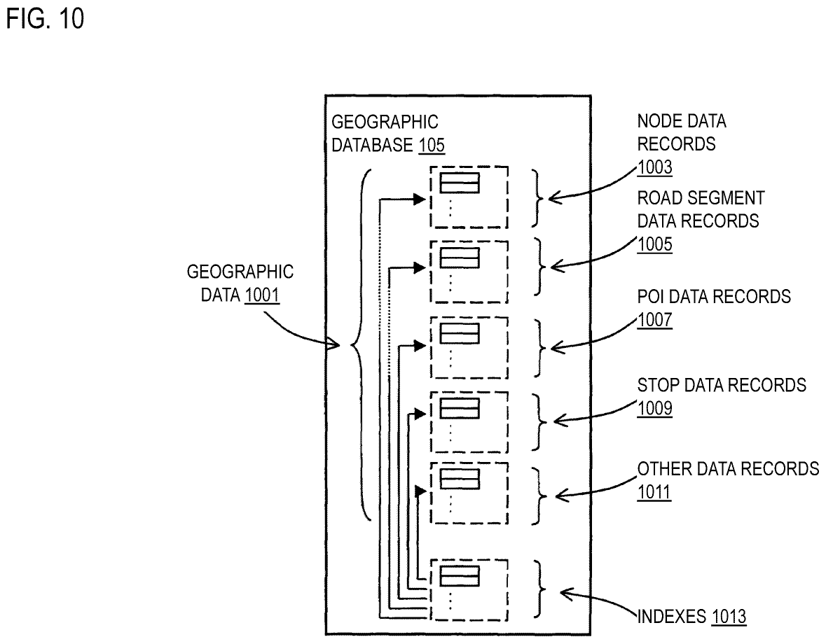

FIG. 10 is a diagram of the geographic database 105, according to one embodiment. In one embodiment, the geographic database 105 includes geographic data 1001 used for (or configured to be compiled to be used for) mapping and/or navigation-related services, such as for video odometry based on the parametric representation of signs include, e.g., encoding and/or decoding parametric representations into object models of signs. In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 105.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 105 follows certain conventions. For example, links do not cross themselves and do not cross each other except at a node. Also, there are no duplicated shape points, nodes, or links. Two links that connect each other have a common node. In the geographic database 105, overlapping geographic features are represented by overlapping polygons. When polygons overlap, the boundary of one polygon crosses the boundary of the other polygon. In the geographic database 105, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 105 includes node data records 1003, road segment or link data records 1005, POI data records 1007, stop data records 1009, other records 1011, and indexes 1013, for example. More, fewer, or different data records can be provided. In one embodiment, additional data records (not shown) can include cartographic (“carto”) data records, routing data, and maneuver data. In one embodiment, the indexes 1013 may improve the speed of data retrieval operations in the geographic database 105. In one embodiment, the indexes 1013 may be used to quickly locate data without having to search every row in the geographic database 105 every time it is accessed. For example, in one embodiment, the indexes 1013 can be a spatial index of the polygon points associated with stored feature polygons.

In exemplary embodiments, the road segment data records 1005 are links or segments representing roads, streets, or paths, as can be used in the calculated route or recorded route information for determination of one or more personalized routes. The node data records 1003 are end points (such as intersections) corresponding to the respective links or segments of the road segment data records 1005. The road link data records 1005 and the node data records 1003 represent a road network, such as used by vehicles, cars, and/or other entities. Alternatively, the geographic database 105 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 105 can include data about the POIs and their respective locations in the POI data records 1007. The geographic database 105 can also include data about places, such as cities, towns, or other communities, and other geographic features, such as bodies of water, mountain ranges, etc. Such place or feature data can be part of the POI data records 1007 or can be associated with POIs or POI data records 1007 (such as a data point used for displaying or representing a position of a city).

In one embodiment, the geographic database 105 can also include stop data records 1009 for storing stop data 109, vehicle drive data 111, aggregated drive geometry data 119, planned maneuver data 121, and/or any related data generated or used according to the various embodiments described herein. In one embodiment, the stop data records 1009 can be associated with one or more of the node records 1003, road segment records 1005, and/or POI data records 1007 to associate the map matching results 119 with specific geographic locations. In this way, the map matching results 119 can also be associated with the characteristics or metadata of the corresponding records 1003, 1005, and/or 1007.

In one embodiment, the geographic database 105 can be maintained by the content provider 127 in association with the mapping platform 107 and/or services platform 123 (e.g., a map developer). The map developer can collect geographic data to generate and enhance the geographic database 105. There can be different ways used by the map developer to collect data. These ways can include obtaining data from other sources, such as municipalities or respective geographic authorities. In addition, the map developer can employ field personnel to travel by vehicle (e.g., vehicle) along roads throughout the geographic region to observe features and/or record information about them, for example. Also, remote sensing, such as aerial or satellite photography, can be used.

The geographic database 105 can be a master geographic database stored in a format that facilitates updating, maintenance, and development. For example, the master geographic database or data in the master geographic database can be in an Oracle spatial format or other spatial format, such as for development or production purposes. Map layers may be utilized. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing driver stopping locations from crowd sourced data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular device, other network device, and/or other computing device.

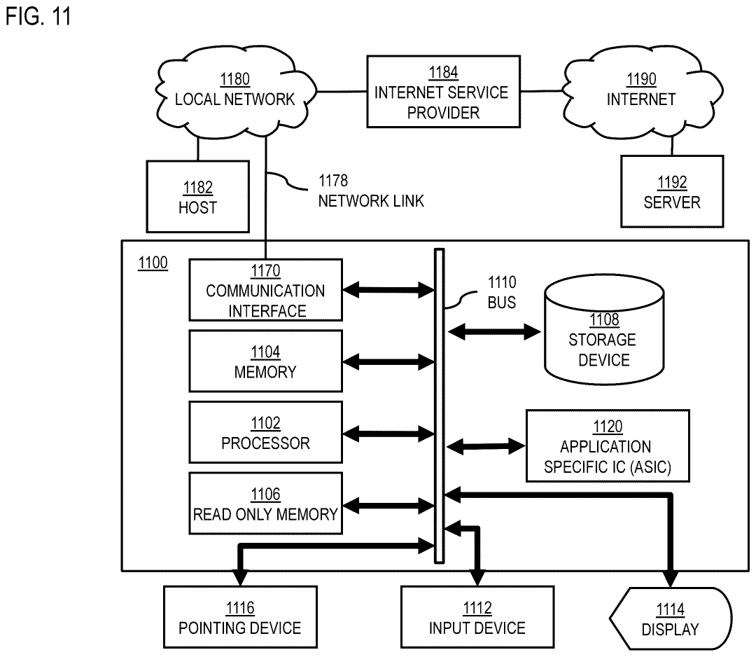

FIG. 11 illustrates a computer system 1100 upon which an embodiment of the invention may be implemented. Computer system 1100 is programmed (e.g., via computer program code or instructions) to provide driver stopping locations from crowd sourced data as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to providing driver stopping locations from crowd sourced data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or other dynamic storage device, stores information including processor instructions for providing driver stopping locations from crowd sourced data. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for providing driver stopping locations from crowd sourced data, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 117 for providing driver stopping locations from crowd sourced data.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system can be deployed in various configurations within other computer systems, e.g., host 1182 and server 1192.

FIG. 12 illustrates a chip set 1200 upon which an embodiment of the invention may be implemented. Chip set 1200 is programmed to provide driver stopping locations from crowd sourced data as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to provide driver stopping locations from crowd sourced data. The memory 1205 also stores the data associated with or generated by the execution of the inventive steps.

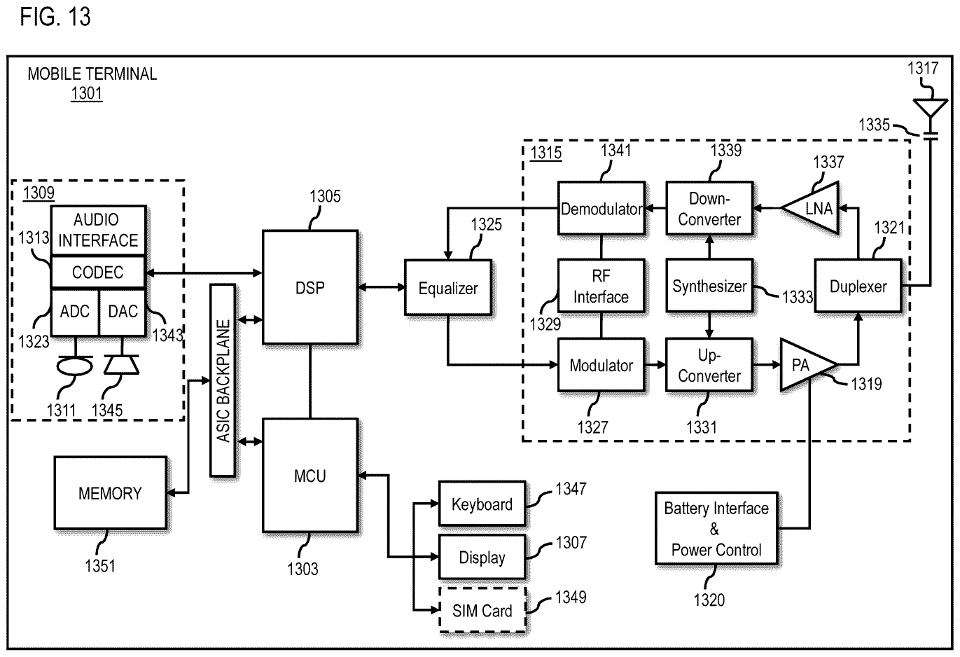

FIG. 13 is a diagram of exemplary components of a mobile terminal (e.g., handset) capable of operating in the system of FIG. 1, according to one embodiment. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile station 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile station 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to provide driver stopping locations from crowd sourced data. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile station 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile station 1301 on a radio network. The card 1349 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
processing vehicle drive data to determine a plurality of aggregated vehicle drive geometries, wherein the vehicle drive data is determined using one or more sensors of one or more vehicles;
associating and clustering the plurality of aggregated vehicle drive geometries into a plurality of vehicle drive path segments;
joining the plurality of vehicle drive path segments in a drive path aggregation model using connectivity coherence of each vehicle drive path segment of the plurality of vehicle drive path segments, wherein each vehicle drive path segment is represented by a node and a segment;
for one or more vehicle drive path segments of the drive path aggregation model, aggregating stop data representing drives that stop within a specific range of the node, the segment, or a combination thereof of the one or more vehicle drive path segments; and
providing the stop data as an output.

2. The method of claim 1, wherein the aggregated vehicle drive geometries are aggregated based on one or more contextual attributes of the one or more vehicles, one or more maneuvers performed by the one or more vehicles, one or more drives performed by the one or more vehicles, one or more environments in which the one or more drives are performed, or a combination thereof.

3. The method of claim 2, wherein the one or more contextual attributes indicates a presence of traffic in front of the one or more vehicles.

4. The method of claim 1, wherein the output is provided as data for planning at least one stop location of a vehicle.

5. The method of claim 1, wherein the stop data is based on a count, a ratio, a stop probability, or a combination thereof of the drives that stop within the specific range.

6. The method of claim 1, wherein the associating of the aggregated vehicle drive geometries is by associating a proximity, a heading, a future maneuver, a past maneuver, or a combination thereof the one or more vehicles.

7. The method of claim 1, wherein the processing of the vehicle drive data to determine the plurality of aggregated vehicle drive geometries comprises performing an aggregation alignment of a plurality of vehicle drives in the vehicle drive data based on one or more features detected during the plurality of vehicle drives by the one or more sensors of the one or more vehicles; and wherein the one or more features include a detected physical object.

8. The method of claim 7, wherein the aggregation alignment comprises:
clustering the one or more detected features into one or more feature clusters based on one or more feature geo-location estimates of the one or more detected features;
determining respective one or more centroids of the one or more feature clusters;
updating geo-location estimates of one or more corresponding drives of the plurality of vehicle drives based on the one or more centroid geo-locations of the respective one or more centroids; and
updating the one or more feature geo-location estimates based on the one or more centroid geo-locations.

9. The method of claim 8, wherein the clustering of the one or more detected features is further based on or more attributes of the one or more detected features.

10. The method of claim 8, wherein the aggregation alignment is iterated recursively until a threshold number of available features align between the one or more corresponding drives.

11. The method of claim 10, wherein one or more additional detected feature types are introduced after completing a designated number of recursions of the aggregation alignment.

12. The method of claim 11, wherein the one or more additional detected feature types include lane-markings.

13. The method of claim 8, wherein the one or more detected features include road signs.

14. The method of claim 1, wherein the one or more detected features are features that are classified as non-ambiguous based on (1) the one or more detected features being a standalone feature with no other feature being detected within a threshold proximity, or (2) the one or more detected features having a feature detection confidence above a threshold confidence.

15. The method of claim 1, wherein the stop data is determined and provided at a lane level.

16. An apparatus comprising:
at least one processor; and
at least one memory including computer program code for one or more programs,
the at least one memory and the computer program code configured to, with the at least one processor, cause the apparatus to:
process vehicle drive data to determine a plurality of aggregated vehicle drive geometries, wherein the vehicle drive data is determined using one or more sensors of one or more vehicles;
associate and cluster the plurality of aggregated vehicle drive geometries into a plurality of vehicle drive path segments;
join the plurality of vehicle drive path segments in a drive path aggregation model using connectivity coherence of each vehicle drive path segment of the plurality of vehicle drive path segments, wherein each vehicle drive path segment is represented by a node and a segment;
for one or more vehicle drive path segments of the drive path aggregation model, aggregate stop data representing drives that stop within a specific range of the node, the segment, or a combination thereof of the one or more vehicle drive path segments; and
provide the stop data as an output.

17. The apparatus of claim 16, wherein the aggregated vehicle drive geometries are aggregated based on one or more contextual attributes of the one or more vehicles, one or more maneuvers performed by the one or more vehicles, one or more drives performed by the one or more vehicles, one or more environments in which the one or more drives are performed, or a combination thereof.

18. The apparatus of claim 17, wherein the one or more contextual attributes indicates a presence of traffic in front of the one or more vehicles.

19. A non-transitory computer-readable storage medium, carrying one or more sequences of one or more instructions which, when executed by one or more processors, cause an apparatus to perform:
processing vehicle drive data to determine a plurality of aggregated vehicle drive geometries, wherein the vehicle drive data is determined using one or more sensors of one or more vehicles;
associating and clustering the plurality of aggregated vehicle drive geometries into a plurality of vehicle drive path segments;
joining the plurality of vehicle drive path segments in a drive path aggregation model using connectivity coherence of each vehicle drive path segment of the plurality of vehicle drive path segments, wherein each vehicle drive path segment is represented by a node and a segment;
for one or more vehicle drive path segments of the drive path aggregation model, aggregating stop data representing drives that stop within a specific range of the node, the segment, or a combination thereof of the one or more vehicle drive path segments; and
providing the stop data as an output.

20. The non-transitory computer-readable storage medium of claim 19, wherein the aggregated vehicle drive geometries are aggregated based on one or more contextual attributes of the one or more vehicles, one or more maneuvers performed by the one or more vehicles, one or more drives performed by the one or more vehicles, one or more environments in which the one or more drives are performed, or a combination thereof.
